(19) United States
(12) Patent Application Publication
(10) Pub. No.: US 2004/0089597 A1
(43) Pub. Date: May 13, 2004

(54) Water filtering device for a faucet

(76) Inventor: Ming-Yuan Hsu, Taichung (TW)

Correspondence Address: Ming-Yuan Hsu, 58, MA YUAN WEST ST., TAICHUNG, TW

(21) Appl. No.: 10/298,110

(22) Filed: Nov. 13, 2002

(51) Int. Cl. B01D 35/02

(52) U.S. Cl. 210/232; 210/459

(57) ABSTRACT

A water filtering device for a faucet includes a mounting seat, a first guide ring, a second guide ring, and a third guide ring. The protruding blocks formed on the top face of the protruding plate of the third guide ring are used to stop and catch the impurities contained in the water flow. In addition, the water flow is stopped by the protruding plate, thereby increasing the water pressure, so that the water flow is injected outward in a strong and intensive manner. Further, the water flow is in turn guided and compressed by the third guide ring, the second guide ring and the first guide ring, so that the water flow is conveyed outward in a smaller, smooth and condensed manner, thereby saving the water.

### BACKGROUND OF THE INVENTION

1. Field of the Invention

The present invention relates to a water filtering device for a faucet, and more particularly to a water filtering device for a faucet, wherein the water flow is stopped by the protruding plate of the third guide ring, thereby increasing the water pressure, so that the water flow is injected outward in a strong and intensive manner.

2. Description of the Related Art

A conventional water filtering device for a faucet is mounted on the water outlet of the faucet, thereby providing proper water filtering and guiding effects. The conventional water filtering device comprises two filtering nets, and a filtering sponge mounted between the two filtering nets. However, the water flow conveyed from the conventional water filtering device is weaker and smaller, thereby decreasing the water flow rate and strength, and thereby causing inconvenience in use.

### SUMMARY OF THE INVENTION

The present invention has arisen to mitigate and/or obviate the disadvantage of the conventional water filtering device for a faucet.

The primary objective of the present invention is to provide a water filtering device for a faucet, wherein the protruding blocks formed oh the top face of the protruding plate of the third guide ring are used to stop and catch the impurities contained in the water flow.

Another objective of the present invention is to provide a water filtering device for a faucet, wherein the water flow is stopped by the protruding plate of the third guide ring, thereby increasing the water pressure, so that the water flow is injected outward in a strong and intensive manner.

A further objective of the present invention is to provide a water filtering device for a faucet, wherein the water flow is in turn guided and compressed by the third guide ring, the second guide ring and the first guide ring, so that the water flow is conveyed outward in a smaller, smooth and condensed manner, thereby saving the water.

In accordance with the present invention, there is provided a water filtering device for a faucet, comprising a mounting seat, a first guide ring, a second guide ring, and a third guide ring, wherein:

the mounting seat has an inner wall formed with a receiving chamber;

the first guide ring is mounted in the mounting seat, and has an upper end formed with an enlarged portion and a lower end formed with a reduced portion, the periphery of the enlarged portion of the first guide ring and the periphery of the reduced portion of the first guide ring are connected by a plurality of ribs, a plurality of water passages are formed between the ribs of the first guide ring;

the second guide ring is mounted in the first guide ring, and has an upper end formed with an enlarged portion and a lower end formed with a reduced portion, the periphery of the enlarged portion of the second guide ring and the periphery of the reduced portion of the second guide ring are connected by a plurality of ribs, a plurality of water passages are formed between the ribs of the second guide ring and are aligned with the water passages of the first guide ring; and

the third guide ring is mounted in the second guide ring, and has an upper end formed with an enlarged portion mounted in the enlarged portion of the second guide ring and a lower end formed with a reduced portion mounted in the reduced portion of the second guide ring, the periphery of the enlarged portion of the third guide ring and the periphery of the reduced portion of the third guide ring are connected by a plurality of ribs, a plurality of water inlet holes are formed between the ribs of the third guide ring and are aligned with the water passage of the second guide ring.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a water filtering device for a faucet in accordance with a preferred embodiment of the present invention;

FIG. 2 is an exploded perspective view of the water filtering device for a faucet in accordance with the preferred embodiment of the present invention;

FIG. 3 is another exploded perspective view of the water filtering device for a faucet in accordance with the preferred embodiment of the present invention; and

FIG. 4 is a side plan cross-sectional assembly view of the water filtering device for a faucet as shown in FIG. 1.

### DETAILED DESCRIPTION OF THE INVENTION

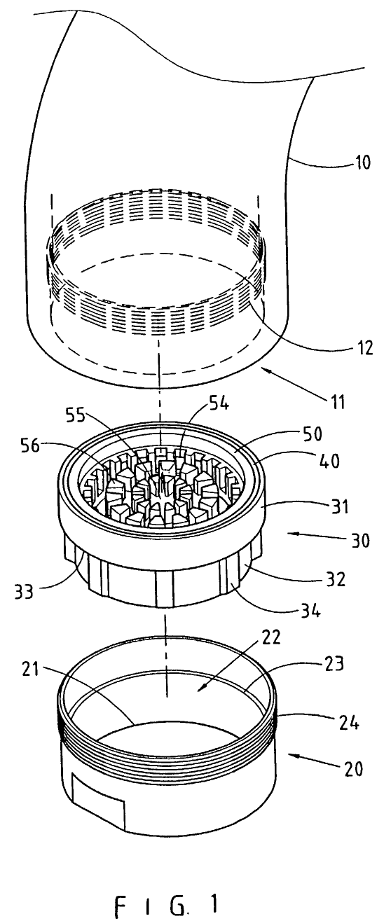

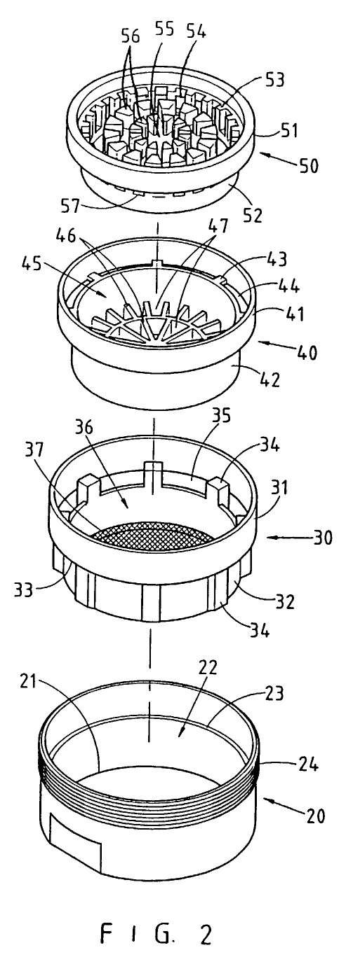

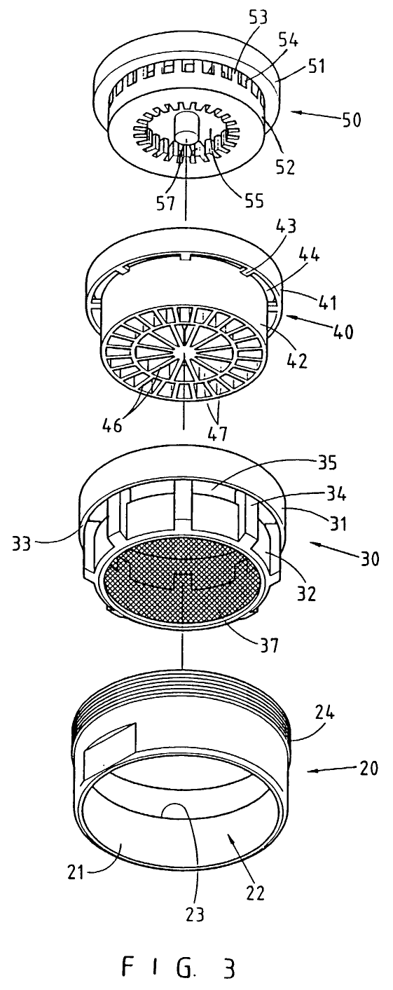

Referring to the drawings and initially to FIGS. 1-3, a water filtering device for a faucet in accordance with a preferred embodiment of the present invention is mounted on the water outlet 11 of a faucet 10, thereby providing proper water filtering and guiding effects.

The water filtering device comprises a mounting seat 20, a first guide ring 30, a second guide ring 40, and a third guide ring 50.

The mounting seat 20 has an inner wall formed with a receiving chamber 22 which has a mediate portion formed with an annular positioning shoulder 23 and a bottom formed with an opening 21. The mounting seat 20 has an outer wall formed with an outer threaded portion 24 screwed into the inner threaded portion 12 of the water outlet 11 of the faucet 10.

The first guide ring 30 is mounted in the mounting seat 20, and has an upper end formed with an enlarged portion 31, a lower end formed with a reduced portion 32 and a mediate portion formed with a stepped portion 33 located between the enlarged portion 31 and the reduced portion 32 and rested on the positioning shoulder 23 of the mounting seat 20. The periphery of the enlarged portion 31 of the first guide ring 30 and the periphery of the reduced portion 32 of the first guide ring 30 are connected by a plurality of ribs 34 that are arranged in an annular manner. A plurality of water passages 35 are formed between the ribs 34 of the first guide ring 30. The first guide ring 30 has an inner wall formed with a central chamber 36 having a bottom provided with a filtering net 37 juxtaposed to the opening 21 of the mounting seat 20.

The second guide ring 40 is mounted in the first guide ring 30, and has an upper end formed with an enlarged portion 41 and a lower end formed with a reduced portion 42. The periphery of the enlarged portion 41 of the second guide ring 40 and the periphery of the reduced portion 42 of the second guide ring 40 are connected by a plurality of ribs 43 that are arranged in an annular manner. A plurality of water passages 44 are formed between the ribs 43 of the second guide ring 40, and are aligned with the water passages 35 of the first guide ring 30. The second guide ring 40 has an inner wall formed with a central chamber 45 having a bottom provided with a plurality of webs 46 formed with a plurality of guide channels 47 aligning with the filtering net 37 of the first guide ring 30. The webs 46 of the second guide ring 40 are arranged in a radiating manner.

The third guide ring 50 is mounted in the second guide ring 40, and has an upper end formed with an enlarged portion 51 mounted in the enlarged portion 41 of the second guide ring 40 and a lower end formed with a reduced portion 52 mounted in the reduced portion 42 of the second guide ring 40. The periphery of the enlarged portion 51 of the third guide ring 50 and the periphery of the reduced portion 52 of the third guide ring 50 are connected by a plurality of ribs 53 that are arranged in an annular manner. A plurality of water inlet holes 54 are formed between the ribs 53 of the third guide ring 50, and are aligned with the water passage 44 of the second guide ring 40. The reduced portion 52 of the third guide ring 50 has a bottom formed with a closed face which has a raised center formed with a protruding plate 55 which has a top face formed with a plurality of spaced protruding blocks 56 that are arranged in a radiating manner. The protruding plate 55 of the third guide ring 50 has an annular wall formed with a plurality of transverse through holes 57 that are arranged in an annular manner.

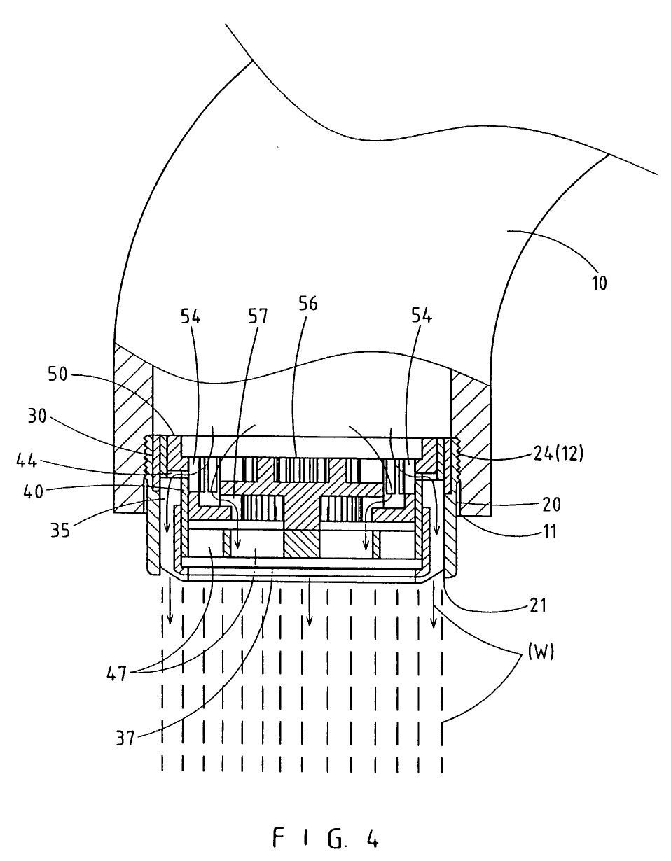

In operation, referring to FIG. 4 with reference to FIGS. 1-3, the water flow “W” are divided into two ways when passing through the water filtering device.

The first way of the water flow “W” is passed through the water inlet holes 54 of the third guide ring 50, the water passage 44 of the second guide ring 40 and the water passages 35 of the first guide ring 30, and is then conveyed outward from the water passages 35 of the first guide ring 30 as shown in FIG. 4.

The second way of the water flow “W” is passed through the transverse through holes 57 of the third guide ring 50, the guide channels 47 of the second guide ring 40 and the filtering net 37 of the first guide ring 30, and is then conveyed outward from the filtering net 37 of the first guide ring 30 as shown in FIG. 4.

In such a manner, the protruding blocks 56 formed on the top face of the protruding plate 55 of the third guide ring 50 are used to stop and catch the impurities contained in the water flow “W”. In addition, the water flow “W” is stopped by the protruding plate 55 of the third guide ring 50, thereby increasing the water pressure, so that the water flow is injected outward in a strong and intensive manner. Further, the water flow “W” is in turn guided and compressed by the third guide ring 50, the second guide ring 40 and the first guide ring 30, so that the water flow “W” is conveyed outward in a smaller, smooth and condensed manner, thereby saving the water.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A water filtering device for a faucet, comprising a mounting seat, a first guide ring, a second guide ring, and a third guide ring, wherein:
the mounting seat has an inner wall formed with a receiving chamber;
the first guide ring is mounted in the mounting seat, and has an upper end formed with an enlarged portion and a lower end formed with a reduced portion, the periphery of the enlarged portion of the first guide ring and the periphery of the reduced portion of the first guide ring are connected by a plurality of ribs, a plurality of water passages are formed between the ribs of the first guide ring;
the second guide ring is mounted in the first guide ring, and has an upper end formed with an enlarged portion and a lower end formed with a reduced portion, the periphery of the enlarged portion of the second guide ring and the periphery of the reduced portion of the second guide ring are connected by a plurality of ribs, a plurality of water passages are formed between the ribs of the second guide ring and are aligned with the water passages of the first guide ring; and
the third guide ring is mounted in the second guide ring, and has an upper end formed with an enlarged portion mounted in the enlarged portion of the second guide ring and a lower end formed with a reduced portion mounted in the reduced portion of the second guide ring, the periphery of the enlarged portion of the third guide ring and the periphery of the reduced portion of the third guide ring are connected by a plurality of ribs, a plurality of water inlet holes are formed between the ribs of the third guide ring and are aligned with the water passage of the second guide ring.

2. The water filtering device for a faucet in accordance with claim 1, wherein the receiving chamber of the mounting seat has a mediate portion formed with an annular positioning shoulder, and the first guide ring has a mediate portion formed with a stepped portion located between the enlarged portion and the reduced portion and rested on the positioning shoulder of the mounting seat.

3. The water filtering device for a faucet in accordance with claim 1, wherein the receiving chamber of the mounting seat has a bottom formed with an opening, and the first guide ring has an inner wall formed with a central chamber having a bottom provided with a filtering net juxtaposed to the opening of the mounting seat.

4. The water filtering device for a faucet in accordance with claim 1, wherein the mounting seat has an outer wall formed with an outer threaded portion screwed into an inner threaded portion of a water outlet of the faucet.

5. The water filtering device for a faucet in accordance with claim 1, wherein the ribs of the first guide ring are arranged in an annular manner.

6. The water filtering device for a faucet in accordance with claim 1, wherein the ribs of the second guide ring are arranged in an annular manner.

7. The water filtering device for a faucet in accordance with claim 3, wherein the second guide ring has an inner wall formed with a central chamber having a bottom provided with a plurality of webs formed with a plurality of guide channels aligning with the filtering net of the first guide ring.

8. The water filtering device for a faucet in accordance with claim 7, wherein the webs of the second guide ring are arranged in a radiating manner.

9. The water filtering device for a faucet in accordance with claim 1, wherein the ribs of the third guide ring are arranged in an annular manner.

10. The water filtering device for a faucet in accordance with claim 1, wherein the reduced portion of the third guide ring has a bottom formed with a closed face which has a raised center formed with a protruding plate which has a top face formed with a plurality of spaced protruding blocks.

11. The water filtering device for a faucet in accordance with claim 10, wherein the protruding blocks are arranged in a radiating manner.

12. The water filtering device for a faucet in accordance with claim 10, wherein the protruding plate of the third guide ring has an annular wall formed with a plurality of transverse through holes.
